(19) United States
(12) Patent Application Publication
(10) Pub. No.: US 2007/0215744 A1
(43) Pub. Date: Sep. 20, 2007

(54) Tape reel and method for manufacturing the same

(75) Inventor: Teruo Sogabe, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/723,376

(22) Filed: Mar. 16, 2007

(30) Foreign Application Priority Data
Mar. 20, 2006 (JP) 2006-075847

(51) Int. Cl. G11B 23/037; B29C 69/00; B29C 65/00

(52) U.S. Cl. 242/608.8; 242/610.6; 264/241

(57) ABSTRACT

A tape reel according to the present invention includes: a disk-shaped first flange; a cylindrical hub; and a disk-shaped second flange. The first flange and the second flange extending in a radial direction from an outer periphery of the hub. At least one flange selected from the first flange and the second flange is joined to the hub with an injection molding resin.

### BACKGROUND OF THE INVENTION

1. Field of the Invention

The present invention relates to a tape reel that achieves high accuracy and a method for manufacturing the same.

2. Description of Related Art

In recent years, means for high-speed information transmission such as optical fibers have made remarkable progress. As a result, it became possible to transmit images and data with an enormous amount of information, while at the same time, there arises an increasing demand for advanced techniques to record, reproduce, and store such images and data. Examples of recording and reproducing media include flexible disks, magnetic drums, hard disks, and magnetic tapes. Tape-shaped recording media such as magnetic tapes play a major role mainly as data backup media, because their recording capacity per reel is large.

Examples of the tape-shaped recording media include magnetic tapes and optical tapes. Usually, the tape-shaped recording medium is used in the state where it is wound around a reel and housed in a cartridge. The reel falls into two types, namely, a two-piece type and a three-piece type. As shown in FIG. 11, a two-piece type reel 100 includes: a hub 102 (a magnetic tape, for example, can be wound around an outer peripheral surface 101 of this hub 102); a disk-shape first flange 103 that has an opening in its center and is fixed to the hub 102 by welding; and a disk-shaped second flange 104 that is formed integrally with the hub 102. The first flange 103 can be joined to the hub 102 by ultrasonic welding, caulking, or the like (see JP10(1998)-320958 A, JP 8(1996)-147929 A, and JP 2001-243739 A, for example).

On the other hand, a three-piece type reel corresponds to, for example, the above-descried two-piece type reel 100 in which the hub 102 and the second flange 104 are provided as separate components. In the three-piece type reel, the first flange, the hub, and the second flange can be joined to each other by snap-fitting or the like (see JP 2002-298542 A, for example).

In both the two-piece type reel and the three-piece type reel, the components thereof generally are manufactured by injection molding of a resin. In the two-piece type reel, the first flange and the hub provided with the second flange are manufactured separately by injection molding. On the other hand, in the three-piece type reel, the first flange, the hub, and the second flange are manufactured separately by injection molding.

FIG. 12 is a schematic view illustrating a conventional process for manufacturing a two-piece type reel by ultrasonic welding. In FIG. 12, a first flange is injection-molded using a first mold 201 of a first injection molding machine 200. A second flange and a hub are integrally injection-molded using a second mold 204 of a second injection molding machine 203. The hub and the second flange formed integrally by the injection molding are fed to a conveyor belt 206 by a hub fetching machine 205. The first flange obtained by the injection molding is fed to the conveyor belt 206 and is placed on the hub by a flange fetching machine 207, thus preparing a reel 208 before welding. Thereafter, the first flange and the hub of the reel 208 are joined to each other by an ultrasonic welding machine 209.

FIG. 13A is a sectional view illustrating a conventional process for joining the first flange to the hub by ultrasonic welding, and FIG. 13B is an enlarged view of a portion B in FIG. 13A. Note here that, in FIGS. 13A and 13B, components other than the hub and the flanges are not shown in cross section. As shown in FIGS. 13A and 13B, the first flange 103 is placed on a pedestal 105 of the hub 102 from above, and a joining rib 106 of the first flange 103 is inserted into a joining groove 107 of the pedestal 105. Then, a welding horn 108 is placed on a rib 109 of the first flange 103 such that a portion to be joined is sandwiched between the welding horn 108 and a receiving jig 110. Finally, the welding horn 108 applies an ultrasonic wave to the portion to be joined to melt a welding projection 111 of the joining rib 106, thereby welding the joining rib 106 to the joining groove 107.

Lately, with an increase in recording capacity of a tape cartridge, further improvement in shape accuracy and rotational accuracy of a reel of the tape cartridge has been demanded. However, when the hub and the flange are joined by ultrasonic welding, vibration energy generated by a welding horn is transferred to portions other than a portion that is intended to be welded. As a result, a problem arises that, in the flange etc. having a shape like a thin plate, residual stress stored during the injection molding is activated, resulting in increased warping of the flange etc. Moreover, in the process of welding the hub and the flange, it is necessary to press the first flange 103 against the hub 102 while melting the joining rib 106, as shown in FIG. 13B. Thus, the first flange 103 moves slightly to the hub 102 side at the time of welding. This, however, arises a problem in that, since the positional accuracy control during the movement of the first flange 103 is difficult, the shape accuracy after the welding is deteriorated.

On the other hand, when the flange is joined by caulking, it is necessary that a caulking hole has a minimum clearance. This makes it difficult to realize fine positional accuracy, resulting in deteriorated shape accuracy after the welding. Furthermore, when the flange is joined by snap-fitting, the components cannot be fixed to each other completely, which poses a problem in that the components cannot be fixed sufficiently after they have been joined, resulting in the deteriorated shape accuracy of the reel as a whole.

When the shape accuracy of the reel is not sufficient as described above, the rotational accuracy of the reel also is deteriorated to make the tape run unstable. This deteriorates the reading accuracy and recording accuracy of recording signals by a drive head, thereby causing errors in reading and recording the recording signals.

### SUMMARY OF THE INVENTION

The present invention is intended to solve the above-described problems and to provide a tape reel that is improved in shape accuracy of the reel as a whole and a method for manufacturing such a tape reel efficiently.

The present invention provides a tape reel including: a disk-shaped first flange; a cylindrical hub; and a disk-shaped second flange. The first flange and the second flange extend in a radial direction from an outer periphery of the hub. At least one flange selected from the first flange and the second flange is joined to the hub with an injection molding resin.

The present invention also provides a method for manufacturing a tape reel that includes: a disk-shaped first flange; a cylindrical hub; and a disk-shaped second flange, the first flange and the second flange extending in a radial direction from an outer periphery of the hub. The method includes the step of: joining at least one flange selected from the first flange and the second flange to the hub with an injection molding resin.

Since the tape reel according to the present invention can achieve high shape accuracy, the rotational accuracy of the reel also is improved, which allows the running stability of the tape to be improved.

Moreover, by the method for manufacturing a tape reel according to the present invention, a tape reel having high shape accuracy can be manufactured efficiently.

### BRIEF DESCRIPTION OF THE DRAWINGS

FIG. 1 is a schematic view illustrating a first injection step in a method for manufacturing a tape reel according to the present invention.

FIG. 2A is a sectional view showing a first injection mold after injection molding has been performed, FIG. 2B is a sectional view showing a second injection mold after injection molding has been performed, and FIG. 2C is a sectional view showing a secondary molding mold.

FIG. 3 is a schematic view showing the state where the first injection mold and the second injection mold are moved by rotating turntables.

FIG. 4 is a schematic view showing the state where a secondary molding mold is constructed by using a robot arm.

FIG. 5 is a schematic view illustrating a second injection step in the method for manufacturing a tape reel according to the present invention.

FIG. 6 is a schematic view showing the state where the secondary molding mold is taken out from a secondary injection molding machine and the first injection mold and the second injection mold are reconstructed.

FIG. 7A is a sectional view showing a tape reel according to the present invention, and FIG. 7B is an enlarged view of a portion B in FIG. 7A.

FIG. 8 is a plan view showing an example of a hub used in a tape reel according to the present invention.

FIG. 9 is a plan view showing another example of a hub used in the tape reel according to the present invention.

FIG. 10 is a plan view showing still another example of a hub used in the tape reel according to the present invention.

FIG. 11 is a sectional view showing a conventional tape reel.

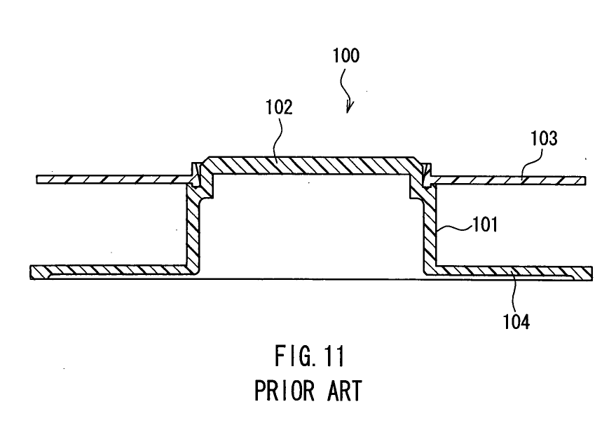

FIG. 12 is a schematic view illustrating a conventional process for manufacturing a tape reel.

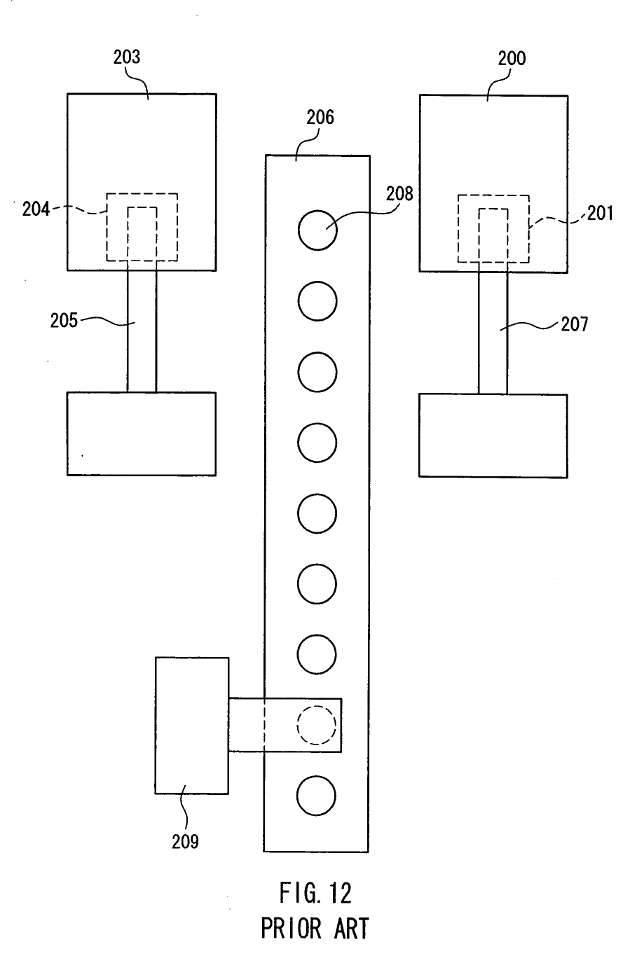

FIG. 13A is a sectional view illustrating a conventional process for joining a flange and a hub by ultrasonic welding, and FIG. 13B is an enlarged view of a portion B in FIG. 13A.

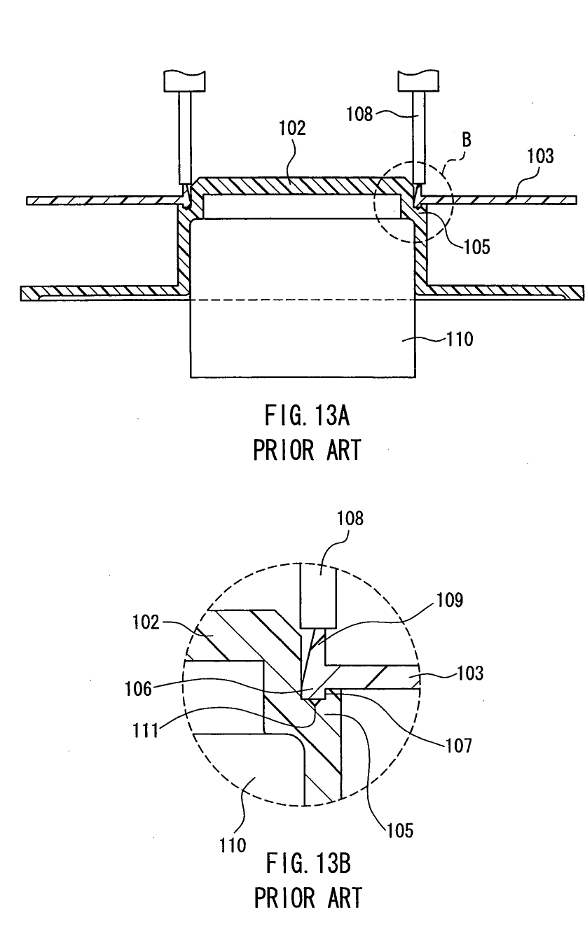

### DETAILED DESCRIPTION OF THE INVENTION

The tape reel according to the present invention includes a disk-shaped first flange, a cylindrical hub, and a disk-shaped second flange. The first flange and the second flange extend in a radial direction from an outer periphery of the hub. The tape reel according to the present invention is not limited to a two-piece type tape reel, and can be a three-piece type tape reel. By configuring the tape reel so as to be of three-piece type, the shape accuracies of the respective components can be improved still further.

Furthermore, in the tape reel according to the present invention, at least one flange selected from the first flange and the second flange is joined to the hub with an injection molding resin. By joining the flange to the hub with an injection molding resin, it becomes possible to join the flange and the hub without applying an external force thereto, as will be described later. This allows the flange to be joined to the hub with high accuracy. As a result, the shape accuracy of the reel is improved and the rotational accuracy of the reel also is improved, which allows the running stability of a tape to be improved. Thus, the reading accuracy and recording accuracy of recording signals by a drive head are improved, whereby errors in reading and recording the recording signals can be reduced.

It is preferable that the injection molding resin fills a portion to be filled with resin (hereinafter referred to as a “resin fill portion”) provided in a joint portion of the at least one flange and the hub. With this configuration, it becomes possible to join the flange and the hub with their positions being fixed.

Preferably, the resin fill portion is formed continuously in a curved shape. This is because, with this configuration, the joint portion of the flange and the hub becomes long, so that the joining strength is enhanced. The resin fill portion can be formed discontinuously in a curved shape. Alternatively, a plurality of resin fill portions can be formed so as to have an island shape.

The first flange can be molded with a first resin, the second flange and the hub can be molded integrally with a second resin, and a third resin can be used as the injection molding resin. With this configuration, the tape reel of two-piece type can be obtained.

The first flange and the second flange can be molded separately with a first resin, the hub can be molded with a second resin, and a third resin can be used as the injection molding resin. With this configuration, the tape reel of three-piece type can be obtained.

Furthermore, the first flange can be molded with a first resin, the second flange and the hub can be molded separately with a second resin, and a third resin can be used as the injection molding resin. Also with this configuration, the tape reel of three-piece type can be obtained.

The first resin, the second resin, and the third resin can be a thermoplastic resin(s). This allows molding and joining of the respective reel components to be performed efficiently by injection molding.

The first resin, the second resin, and the third resin can all be the same resin. With this configuration, the respective resins have the same melting point, so that, at the time of joining the respective components, the temperature for melting and joining can be set easily.

One resin selected from the first resin, the second resin, and the third resin may be different from the remaining resins, or alternatively, they may be different from one another. However, it is preferable that the melting points of the respective resins are dose to one another, because the joining with the third resin (the injection molding resin) is achieved by melting the first resin and the second resin through the heat of the melted third resin.

Preferably, at least one resin selected from the first resin and the second resin is a light-transmitting resin. With this configuration, it becomes possible to check the winding state of a tape visually from the outside during the use of the tape reel as a finished product, so that abnormality of the tape can be detected beforehand. Of course, a light-transmitting resin can be used as the third resin.

The tape reel according to the present invention is applicable not only to a single-reel type tape cartridge but also to a double-reel type tape cartridge. Moreover, the tape reel according to the present invention can be used not only as a reel of a tape cartridge but also as a reel of a drive.

On the other hand, a method for manufacturing the tape reel according to the present invention includes the step of joining at least one flange selected from the first flange and the second flange to the hub with an injection molding resin. By joining the flange to the hub with the injection molding resin, it becomes possible to prevent energy from being transferred to portions other than a portion to be welded, thus preventing the warping and deformation of the flange etc. Moreover, since it is possible to join the flange, which is prone to be deformed, without applying an external force thereto, the joining accuracy can be improved. Therefore, the shape accuracy of the reel can be improved and the rotational accuracy of the reel also is improved, which allows the running stability of a tape to be improved.

More specifically, the method for manufacturing a tape reel according to the present invention includes the steps of injection-molding the first flange using a first injection mold; injection-molding the second flange and the hub integrally using a second injection mold; dividing the first injection mold into separate segments while allowing the first flange to be held inside a first split mold as one of the segments; dividing the second injection mold into separate segments while allowing the second flange and the hub that have been formed integrally to be held inside a second split mold as one of the segments; combining the first split mold and the second split mold with each other so that the first flange and the hub face each other; and filling a resin fill portion provided in a joint portion of the first flange and the hub with the injection molding resin. With this configuration, in this state where the mold accuracy is maintained, a two-piece type reel can be manufactured with high shape accuracy.

Furthermore, the method for manufacturing a tape reel according to the present invention includes the steps of: injection-molding the first flange or the second flange using a first injection mold; injection-molding the hub using a second injection mold; dividing the first injection mold into separate segments while allowing the first flange or the second flange to be held inside a first split mold as one of the segments; dividing the second injection mold into separate segments while allowing the hub to be held inside a second split mold as one of the segments; combining the first split mold and the second split mold with each other so that the first flange or the second flange and the hub face each other; and filling a resin fill portion provided in a joint portion of the first flange or the second flange and the hub with the injection molding resin. With this configuration, in this state where the mold accuracy is maintained, a three-piece type reel can be manufactured with high shape accuracy.

Hereinafter, the present invention will be described by way of illustrative embodiments with reference to the drawings. Although the following embodiments are directed mainly to the case where the present invention is applied to a two-piece type reel, it is to be noted that the present invention also is applicable to a three-piece type reel.

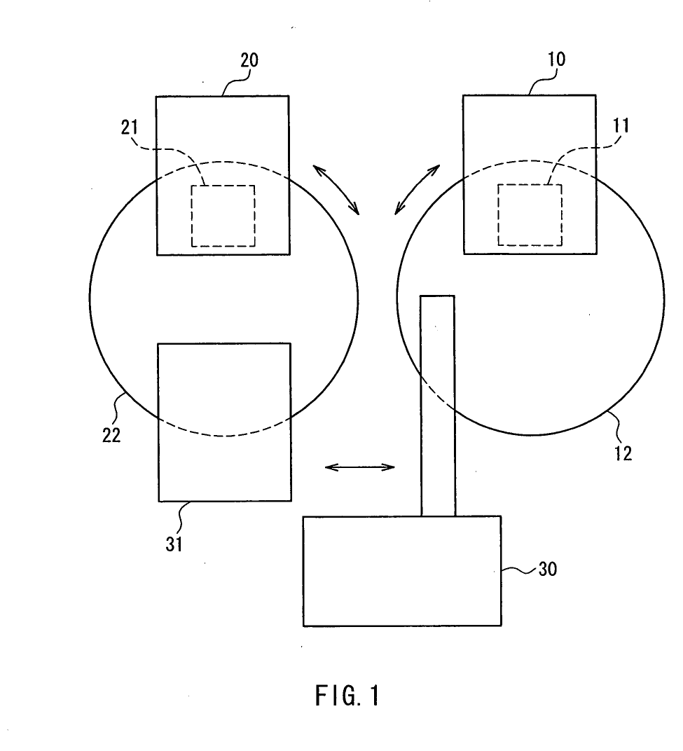

First, one example of a method for manufacturing a tape reel according to the present invention will be described with reference to FIGS. 1 to 6. Note here that, in FIGS. 1 to 6, the same components are given the same reference numerals and the duplicate description may be omitted.

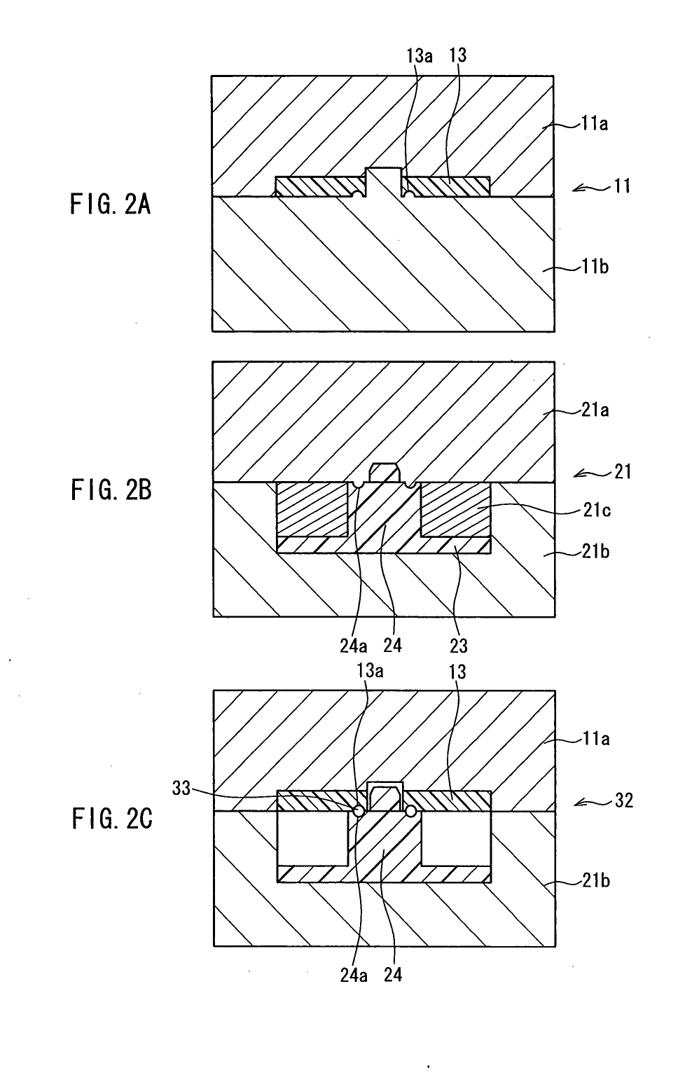

FIG. 1 is a schematic view illustrating a first injection step in a method for manufacturing a tape reel according to the present invention. In FIG. 1, a first flange is injection-molded using a first injection mold 11 of a first vertical-type primary injection molding machine 10. The first injection mold 11 is fixed on a first turntable 12 and can be moved to the position of a robot arm 30 by the rotation of the first turntable 12. FIG. 2A is a sectional view showing the first injection mold 11 after the injection molding has been performed. The first injection mold 11 is composed of an upper mold 11a and a lower mold 11b. The first flange 13 is molded by filling the first injection mold 11 with a first thermoplastic resin. The first flange 13 is molded so as to have joining grooves 13a.

Furthermore, in FIG. 1, a second flange and a hub are integrally injection-molded using a second injection mold 21 of a second vertical-type primary injection molding machine 20. The second injection mold 21 is fixed on a second turntable 22 and can be moved to a portion near the robot arm 30 by the rotation of the second turntable 22. A secondary injection molding machine 31 is placed so as to face the second vertical-type primary injection molding machine 20. FIG. 2B is a sectional view showing the second injection mold 21 after the injection molding has been performed. The second injection mold 21 is composed of an upper mold 21a, a lower mold 21b, and a ring-shaped core 21c. The second flange 23 and the hub 24 are molded by filling the second injection mold 21 with a second thermoplastic resin. The hub 24 is molded so as to have joining grooves 24a.

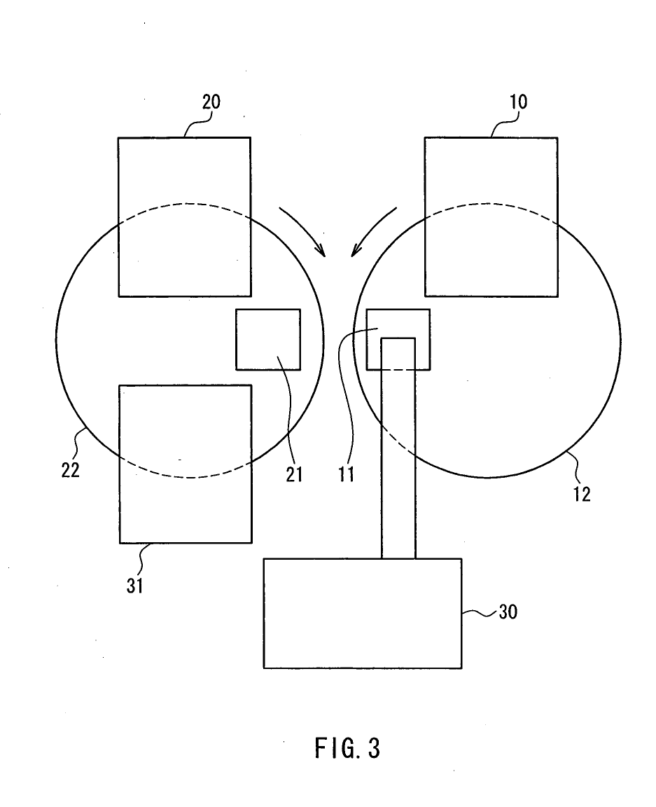

Next, as shown in FIG. 3, the first turntable 12 is rotated so as to bring the first injection mold 11 to the position of the robot arm 30. Similarly, the second injection mold 21 is moved to the position at which it faces the first injection mold 11. Thereafter, using the robot arm 30, the first injection mold 11 is divided, and the upper mold 11a is separated from the lower mold 11b (this step is not illustrated). In this state, the first flange 13 is held inside the upper mold 11a. Subsequently, the second injection mold 21 is divided, and the upper mold 21a is separated from the lower mold 21b and also the ring-shaped core 21c is removed (this step is not illustrated). In this state, the second flange 23 and the hub 24 that have been formed integrally are held inside the lower mold 21b.

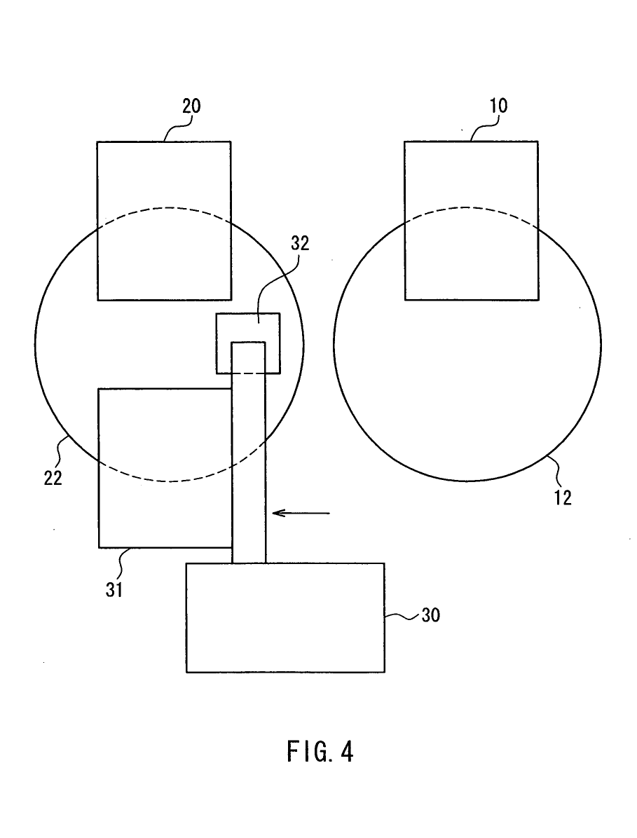

Next, as shown in FIG. 4, the upper mold 11a is placed on the lower mold 21b using the robot arm 30 (this step is not illustrated), whereby a secondary molding mold 32 is constructed. At this time, in order to make the position adjustment of the upper mold 11a and the lower mold 21b easier, it is preferable that each one of the upper mold 11a and the lower mold 21b has a guide pin (not shown) that fits with a hole provided in the other mold. FIG. 2C is a sectional view showing the secondary molding mold 32. In FIG. 2C, the first flange 13 and the hub 24 are arranged so as to face each other, and the joining grooves 13a of the first flange 13 and the joining grooves 24a of the hub 24 form a resin fill portion 33 for secondary molding. The resin fill portion 33 may be formed so as to extend along the entire circumference of the hub 24, or alternatively, it may be formed so as to lie only partially along the circumference of the hub 24.

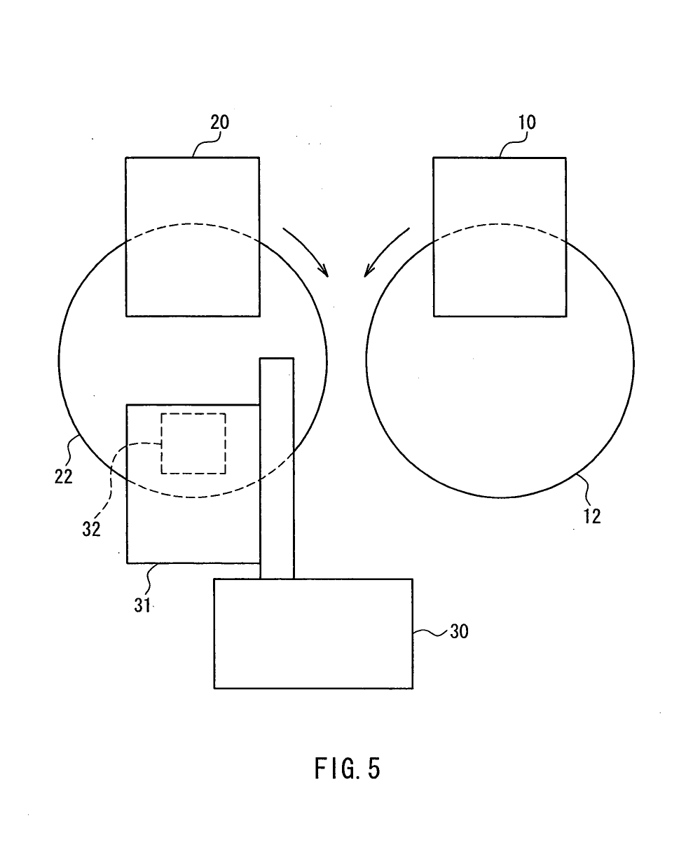

Next, as shown in FIG. 5, the second turntable 22 is rotated so as to bring the secondary molding mold 32 to the position of the secondary injection molding machine 31. Thereafter, the resin fill portion 33 (FIG. 2C) of the secondary molding mold 32 is filled with a melted third thermoplastic resin. By the heat of this melted resin (the third thermoplastic resin), the first flange 13 (made of the first thermoplastic resin) and the hub 24 (made of the second thermoplastic resin) that are in contact with the resin fill portion 33 are melted and then cooled, whereby the first flange 13 and the hub 24 are welded with the third thermoplastic resin.

Next, the secondary molding mold 32 is taken out of the secondary injection molding machine 31 by rotating the second turntable 22, and the upper mold 11a is separated from the secondary molding mold 32 using the robot arm 30 (this step is not illustrated). At this time, the reel obtained by joining the first flange 13 and the hub 24 is held inside the lower mold 21b by mold release resistance (this state is not illustrated). After that, the reel is taken out of the lower mold 21b by the robot arm 30. Through the above-described process, the tape reel with high shape accuracy according to the present invention is manufactured.

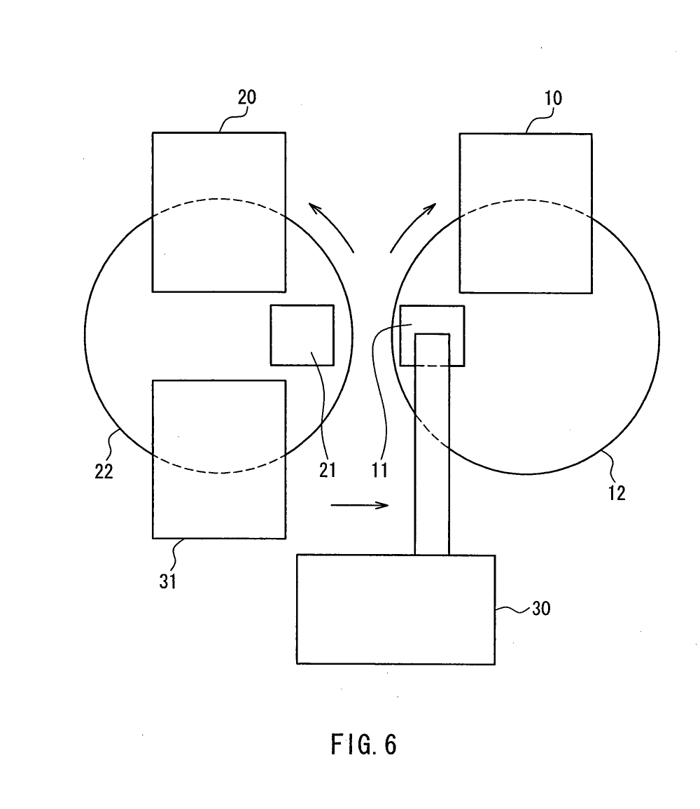

Next, as shown in FIG. 6, the upper mold 11a is placed on the lower mold 11b that is on the first turntable 12 by the robot arm 30 (this step is not illustrated). Thus, the first injection mold 11 is reconstructed. The ring-shaped core 21c is inserted into the lower mold 21b, and then the upper mold 21a is placed on the lower mold 21b (this step is not illustrated). Thus, the second injection mold 21 is reconstructed. Thereafter, the first injection mold 11 and the second injection mold 21 are put back to the first vertical-type primary injection molding machine 10 and the second vertical-type primary injection molding machine 20, respectively, so that they can be used in a first injection step again.

In the above-described manufacturing process, dividing, feeding, etc. of the molds by the robot arm 30 can be achieved by means of a magnet, suction, or the like. Although the injection molding machines used in the present embodiment are all vertical-type injection molding machines, it is also possible to use horizontal-type injection molding machines.

As the first thermoplastic resin, the second thermoplastic resin, and the third thermoplastic resin, it is possible to use polycarbonate, polystyrene, acrylonitrile-styrene resin, polyacetal, acrylonitrile-butadiene-styrene resin, etc., for example. Although these resins can be used as they are without being subjected to coloring or the like, they may be colored with a coloring agent such as a pigment or a dye.

The first thermoplastic resin, the second thermoplastic resin, and the third thermoplastic resin can all be the same resin. Alternatively, one resin selected from the first thermoplastic resin, the second thermoplastic resin, and the third thermoplastic resin may be different from the remaining resins, or they may be different from one another. However, it is preferable that the melting points of the respective resins are close to one another, because the joining with the third thermoplastic resin (the injection molding resin) is achieved by melting the first thermoplastic resin and the second thermoplastic resin through the heat of the melted third thermoplastic resin.

Preferably, at least one resin selected from the first thermoplastic resin and the second thermoplastic resin is a light-transmitting resin. With this configuration, it becomes possible to check the winding state of a tape visually from the outside of the tape reel as a finished product, so that abnormality of the tape can be detected beforehand. Of course, a light-transmitting resin can be used as the third thermoplastic resin.

A two-piece type reel according to the present invention can be manufactured through the above-described process. In the case of three-piece type reel, it can be manufactured by primary molding the first flange, the second flange, and the hub separately using an additional primary injection molding machine, primary injection mold, etc., and then performing the joining of the first flange to the hub and the second flange to the hub with an injection molding resin through the secondary molding in the above-described manner.

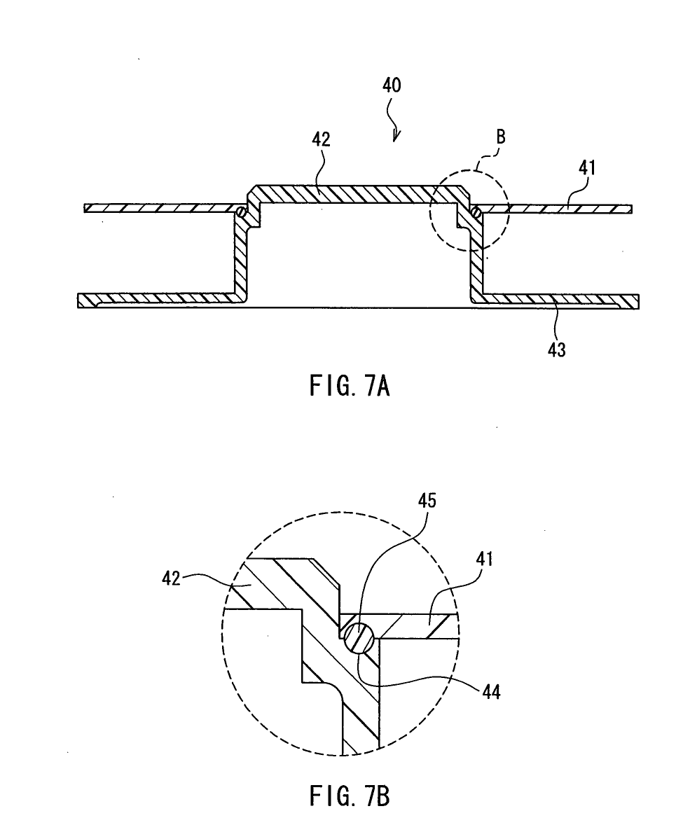

Next, one example of a tape reel according to the present invention will be described with reference to FIGS. 7 to 10. FIG. 7A is a sectional view showing a tape reel according to the present invention, and FIG. 7B is an enlarged view of a portion B in FIG. 7A.

In FIGS. 7A and 7B, a reel 40 includes a disk-shaped first flange 41, a cylindrical hub 42, and a disk-shaped second flange 43. The first flange 41 and the second flange 43 extend in the radial direction from an outer periphery of the hub 42. The second flange 43 and the hub 42 are formed integrally. Furthermore, a resin fill portion 44 is provided in the joint portion of the first flange 41 and the hub 42, and the resin fill portion 44 is filled with an injection molding resin 45. That is, the first flange 41 and the hub 42 are joined to each other with the injection molding resin 45.

The tape reel according to the present invention can be manufactured by the above-described method for manufacturing a tape reel according to the present invention. Thus, the shape accuracy of the reel is improved and the rotational accuracy of the reel also is improved, which allows the running stability of a tape to be improved. Thus, the reading accuracy and recording accuracy of recording signals by the drive head are improved, whereby errors in reading and recording the recording signals can be reduced.

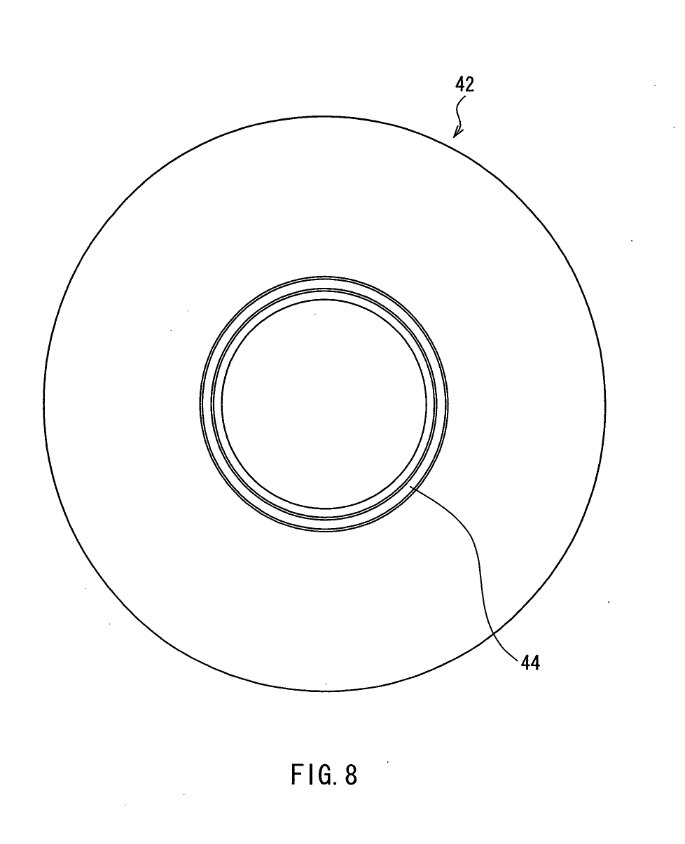

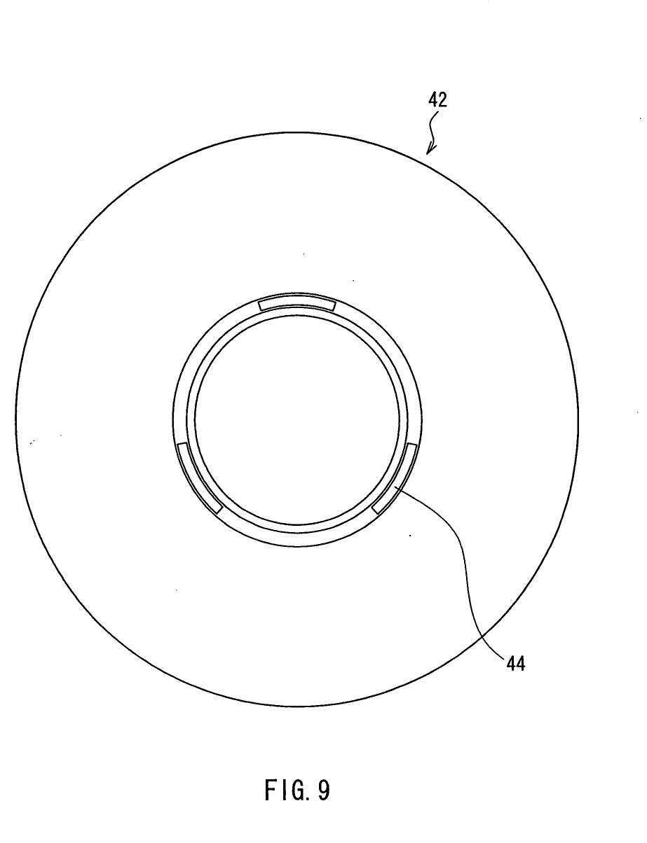

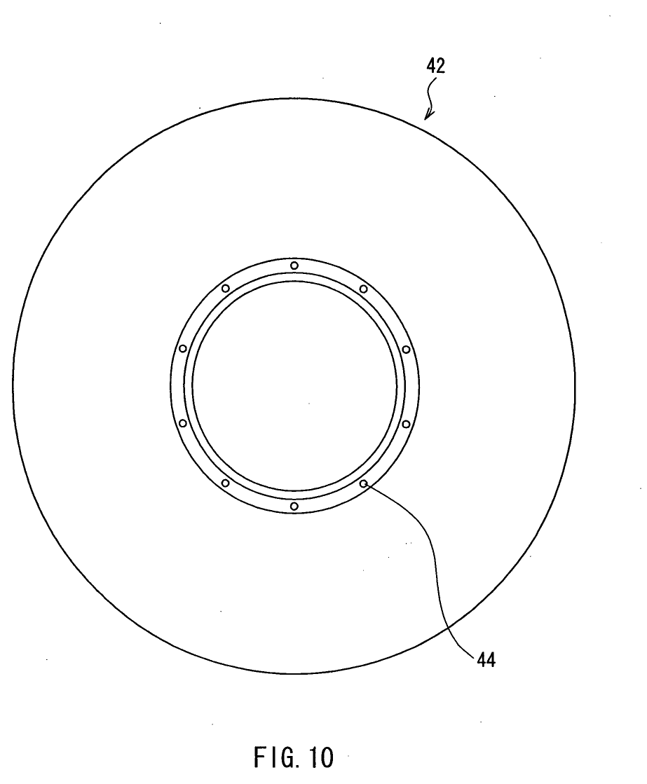

FIGS. 8 to 10 are plan views showing the hub 42 in the state where the first flange 41 and the injection molding resin 45 are removed from the reel 40 shown in FIG. 7A. Although there is no particular limitation on the shape of the resin fill portion 44, it is preferable that the resin fill portion 44 is formed continuously in a circular shape (a curved shape) as shown in FIG. 8. This is because, with this configuration, the joint portion of the first flange 41 (FIG. 7A) and the hub 42 becomes long, so that the joining strength is enhanced. Note here that the resin fill portion 44 can be formed discontinuously in a curved shape as shown in FIG. 9. Alternatively, a plurality of island-shaped resin fill portions 44 may be formed as shown in FIG. 10.

As the materials of the first flange 41, the second flange 43, and the hub 42, it is possible to use the same resins as those described with regard to the above-described method for manufacturing a tape reel according to the present invention.

As specifically described above, since the tape reel according to the present invention can achieve high shape accuracy, the rotational accuracy of the reel also is improved, which allows the running stability of the tape to be improved. Consequently, the tape reel according to the present invention can contribute to higher performance of tape cartridges. Moreover, by the method for manufacturing a tape reel according to the present invention, the above-described tape reel of the present invention can be manufactured efficiently. Thus, the method according to the present invention is extremely valuable from an industrial viewpoint.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A tape reel comprising:
a disk-shaped first flange;
a cylindrical hub; and
a disk-shaped second flange,
the first flange and the second flange extending in a radial direction from an outer periphery of the hub,
wherein at least one flange selected from the first flange and the second flange is joined to the hub with an injection molding resin.

2. The tape reel according to claim 1, wherein a resin fill portion is provided in a joint portion of the at least one flange and the hub, and the resin fill portion is filled with the injection molding resin.

3. The tape reel according to claim 2, wherein the resin fill portion is formed continuously in a curved shape.

4. The tape reel according to claim 2, wherein the resin fill portion is formed discontinuously in a curved shape.

5. The tape reel according to claim 2, wherein a plurality of said resin fill portions are formed so as to have an island shape.

6. The tape reel according to claim 1, wherein the first flange is molded with a first resin, the second flange and the hub are molded integrally with a second resin, and a third resin is used as the injection molding resin.

7. The tape reel according to claim 1, wherein the first flange and the second flange are molded separately with a first resin, the hub is molded with a second resin, and a third resin is used as the injection molding resin.

8. The tape reel according to claim 1, wherein the first flange is molded with a first resin, the second flange and the hub are molded separately with a second resin, and a third resin is used as the injection molding resin.

9. The tape reel according to claim 6, wherein the first resin, the second resin, and the third resin are a thermoplastic resin.

10. The tape reel according to claim 7, wherein the first resin, the second resin, and the third resin are a thermoplastic resin.

11. The tape reel according to claim 8, wherein the first resin, the second resin, and the third resin are a thermoplastic resin.

12. The tape reel according to claim 6, wherein the first resin, the second resin, and the third resin are all the same resin.

13. The tape reel according to claim 7, wherein the first resin, the second resin, and the third resin are all the same resin.

14. The tape reel according to claim 8, wherein the first resin, the second resin, and the third resin are all the same resin.

15. The tape reel according to claim 6, wherein one resin selected from the first resin, the second resin, and the third resin is different from the remaining resins.

16. The tape reel according to claim 7, wherein one resin selected from the first resin, the second resin, and the third resin is different from the remaining resins.

17. The tape reel according to claim 8, wherein one resin selected from the first resin, the second resin, and the third resin is different from the remaining resins.

18. The tape reel according to claim 6, wherein the first resin, the second resin, and the third resin are different from one another.

19. The tape reel according to claim 7, wherein the first resin, the second resin, and the third resin are different from one another.

20. The tape reel according to claim 8, wherein the first resin, the second resin, and the third resin are different from one another.

21. The tape reel according to claim 6, wherein at least one resin selected from the first resin and the second resin is a light-transmitting resin.

22. The tape reel according to claim 7, wherein at least one resin selected from the first resin and the second resin is a light-transmitting resin.

23. The tape reel according to claim 8, wherein at least one resin selected from the first resin and the second resin is a light-transmitting resin.

24. A method for manufacturing a tape reel,
the tape reel comprising:
a disk-shaped first flange;
a cylindrical hub; and
a disk-shaped second flange,
the first flange and the second flange extending in a radial direction from an outer periphery of the hub,
the method comprising the step of:
joining at least one flange selected from the first flange and the second flange to the hub with an injection molding resin.

25. The method according to claim 24, comprising the steps of:
injection-molding the first flange using a first injection mold;
injection-molding the second flange and the hub integrally using a second injection mold;
dividing the first injection mold into separate segments while allowing the first flange to be held inside a first split mold as one of the segments;
dividing the second injection mold into separate segments while allowing the second flange and the hub that have been formed integrally to be held inside a second split mold as one of the segments;
combining the first split mold and the second split mold with each other so that the first flange and the hub face each other; and
filling a resin fill portion provided in a joint portion of the first flange and the hub with the injection molding resin.

26. The method according to claim 24, comprising the steps of:
injection-molding the first flange or the second flange using a first injection mold;
injection-molding the hub using a second injection mold;
dividing the first injection mold into separate segments while allowing the first flange or the second flange to be held inside a first split mold as one of the segments;
dividing the second injection mold into separate segments while allowing the hub to be held inside a second split mold as one of the segments;
combining the first split mold and the second split mold with each other so that the first flange or the second flange and the hub face each other; and
filling a resin fill portion provided in a joint portion of the first flange or the second flange and the hub with the injection molding resin.

27. The method according to claim 24, comprising the steps of:
joining the first flange to the hub with an injection molding resin; and
joining the second flange to the hub with an injection molding resin.
